(19) United States
(12) Patent Application Publication
(10) Pub. No.: US 2010/0148488 A1
(43) Pub. Date: Jun. 17, 2010

(54) Coupler fitting with male and female joint ends

(75) Inventor: Paul E. Homola, Woodland, WA (US)

Correspondence Address: Paul E. Homola, Po Box 1378, Woodland, WA, 98674, US

(73) Assignee: Paul Edwin Homola, Woodland, WA (US)

(21) Appl. No.: 12/589,485

(22) Filed: Oct. 22, 2009

Related U.S. Application Data
(60) Provisional application No. 61/201,780, filed on Dec. 15, 2008.

(51) Int. Cl. F16L 55/00

(52) U.S. Cl. 285/12

(57) ABSTRACT

A pipe, hose, or tube coupler fitting that has a male and a female adaption joint on one or all of its ends and a body that connects these ends. On the outermost end of the fitting body (10) is a female (14) joint that can connect to a male pipe end, and then immediately behind this female joint, is a male (12) joint. To do this, the body of the coupler fitting immediately behind the female joint is sized inside (16) diameter and outside (18) diameter, to the same size of its corresponding connecting pipes' inside diameter and outside diameter, and continues this size throughout a length (20) a minimum of its female joint length (28), thus becoming a male joint once said female joint is removed. Once said female joint is removed by cutting, unthreading or anyway removed, the male joint can be used. This new coupler fitting's end or ends are universal male or female, whichever is needed.

### CROSS REFERENCE TO RELATED APPLICATIONS

PPA 61/201,780 filed on Dec. 15, 2008

### FEDERALLY SPONSORED RESEARCH AND DEVELOPMENT

Not applicable

### SEQUENCE LISTING OR PROGRAM

Not applicable

### FIELD OF INVENTION

This invention relates to the connecting of pipes and hoses with a faster, more economic coupler fitting that will reduce the installation time, supplies, and space.

### BACKGROUND OF THE INVENTION

The construction of piping systems as in plumbing systems requires pipe with male or female ends and connecting fittings such as: tee's, Y's, elbow's (90, 45, 22, 60 etc) with male or female ends. Previous and currently in use coupler fittings have a body and adaption joint ends. The body connects said joint ends. These ends have either male or female joints on them, but not both. Currently, when connecting a Y fitting to an elbow fitting, a male ended elbow fitting is needed. When connecting two pieces of pipe with an elbow fitting, a female ended elbow fitting is needed. This requires the on hand supply of both male and female ended fittings in all pipe sizes and designs: (tees, Y's, and elbows). This scenario happens continually in piping systems.

The present invention is a coupler fitting with both male and female joints on all ends of the fitting. With this new design, it removes the need for supplying double the amount of fittings, (one male and one female of all sizes and designs) saving valuable money and space. Secondly, the installation time saved without having to search for the right fitting with the right end is substantial. Lastly, the tee, y, and combination fittings with the new dual male and female ends will make the connections closer requiring less space, considering the tight places pipes must fit in walls and ceilings.

### SUMMARY OF THE INVENTION

A coupler fitting with ends that are female and male joint adaptable, whichever is needed. The new design is to add a male (also called spiket or street) joint immediately behind a female (also called hub or socket) joint on the same end of fitting. On the outermost end of the fitting body is a female joint that can connect to a male pipe end, and then immediately behind this female joint, is a male joint. To do this, the body of the coupler fitting immediately behind the female joint is sized inside diameter and outside diameter, to the same size of its corresponding connecting pipes' inside diameter and outside diameter, and continues this size throughout a length a minimum of its female joint length, thus making It a male joint once the female joint is removed.

The female joint is removed by cutting it off, leaving the male joint ready for use. The method to remove the female joint should not be limited by this example but unthreading or any method deemed necessary to remove the female joint applies. Thus, the coupler fitting end is a female joint initially and when a male joint is desired, the female joint is removed, becoming a male joint ended coupler fitting.

### DRAWINGS—BRIEF DESCRIPTION

FIG. 1 shows prior art of an existing fitting used today with a male joint on one end and a female joint on the other end.

FIG. 2 shows a coupler fitting with the preferred embodiment of both a male and a female joint on both ends.

FIG. 3 shows a close up view of the coupler fitting end with the preferred embodiments.

FIG. 4 shows the present invention coupler fitting with the female joint removed and the remaining end which is a male joint ready for use.

FIG. 5 shows two coupler fittings connected with the preferred embodiments.

FIG. 6 shows an alternative embodiment.

### DRAWINGS—REFERENCE NUMERALS

### 10—Body

12—Male joint
14—Female joint
16—Inside diameter of male joint
18—Outside diameter of male joint
20—Length of male joint end
22—Cut line/etched mark
24—Instruction to user “Cut on dotted line”
26—Removal tool “goof” space
28—Female joint length

### DRAWINGS—DETAILED DESCRIPTION

For this description, pipe coupler fittings made of plastic with slip joints that are to be glued will be used, but it should be understood that this invention applies to any pipe, hose, or tube connecting fitting made of any material be it a metal, plastic, engineered plastic, rubber, etc.

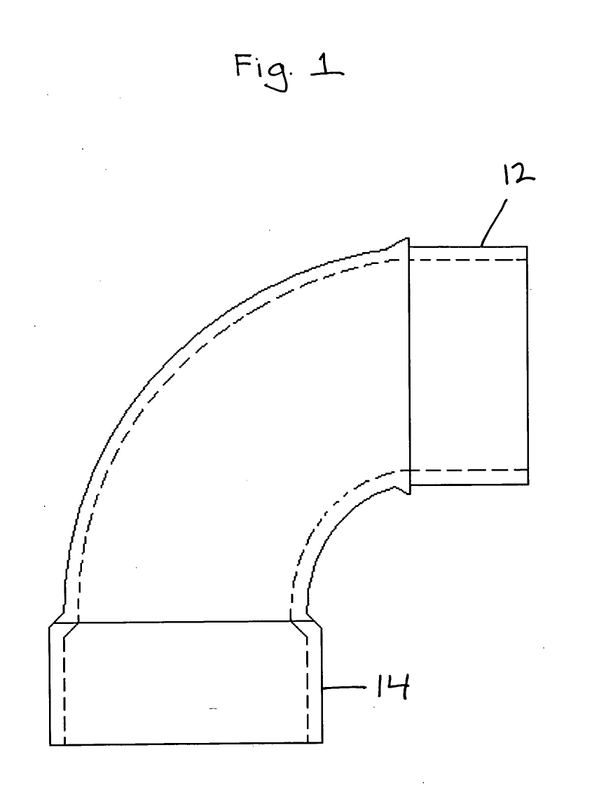

FIG. 1 shows prior art of an existing fitting used today with a male joint on one end and a female joint on the other end.

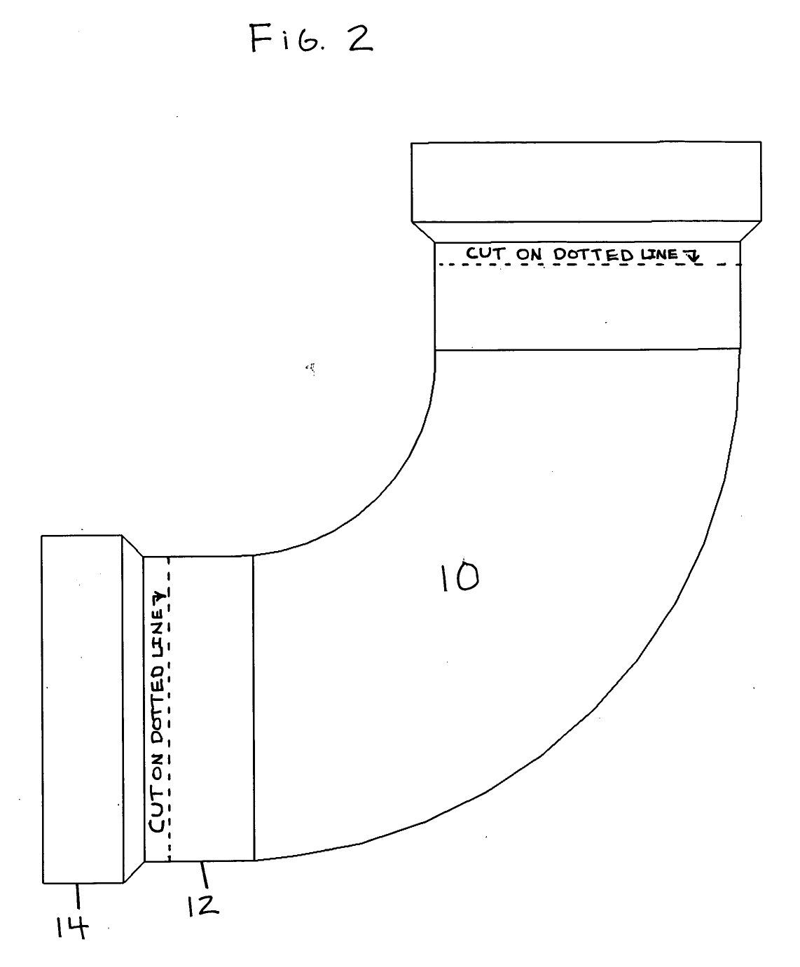

FIG. 2 shows a coupler fitting with a preferred embodiment, comprising a body 10 and both a male 12 joint and a female 14 joint on both ends. This embodiment adds the male 12 joint immediately behind the female 14 joint.

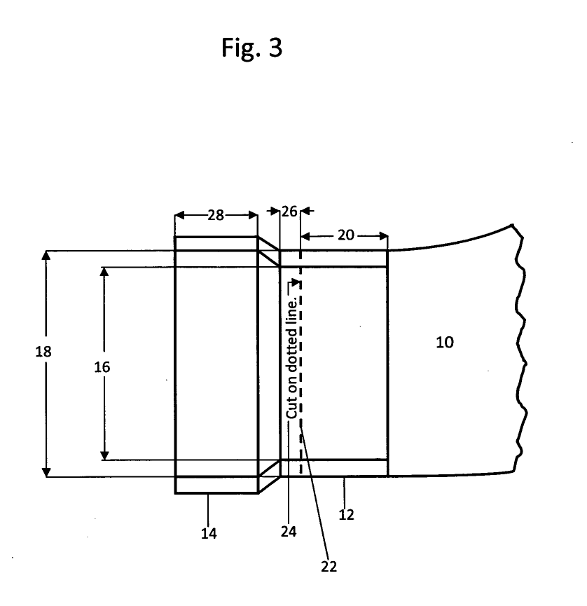

FIG. 3 shows a close up view of a coupler fitting end with the preferred embodiment of a body 10, a male 12 joint and a female 14 joint. The part of the body 10 immediately behind the female 14 joint is sized inside diameter 16 and outside diameter 18 to the same size as the coupler fitting's corresponding connecting pipes' inside diameter and outside diameter, and continues this size throughout a length 20 a minimum of its female 14 joint length 28, therefore making it male joint size and becoming a male 12 joint once said female 14 joint is removed.

The female 14 joint length 28 for the above description is derived from coupler fittings currently in use or from standard fitting and pipe sizes set forth by international standards, including API 5L, ANSI/ASME B36.10M and B36.19M in the USA, BS 1600 and BS EN 10255 in the United Kingdom and Europe, and ISO 65 internationally.

Another embodiment shown in FIG. 3 is a cut line 22 or etched mark put on the male 12 joint part of the body 10 as a dotted line and the words as instructions to user 24 Cut on dotted line or whatever deemed necessary as a guide where to cut. This cut line 22 or etched mark is on the male 12 joint part of the body 10 an eighth (⅛) inch back from the female 14 joint, when measuring from said female 14 joint where it meets the male 12 joint, towards the body 10. This extra eighth (⅛) inch is room for a saw blade or a removal tool's 26 “goof” space. Once the female 14 joint is removed by cutting on cut line 22 or etched mark, the remaining end 20 of body 10 as previously stated becomes a male 12 joint end. The above descriptions of embodiments are for coupler fittings sized 0 to 14 inches and beyond.

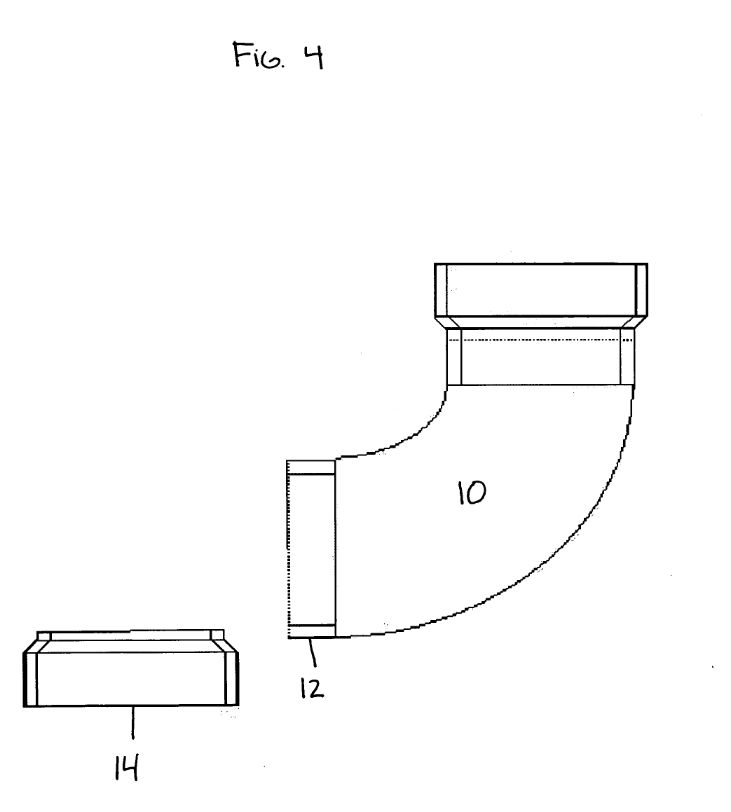

FIG. 4 shows the present invention coupler fitting with the female 14 joint removed and the remaining end which is a male 12 joint, ready for use.

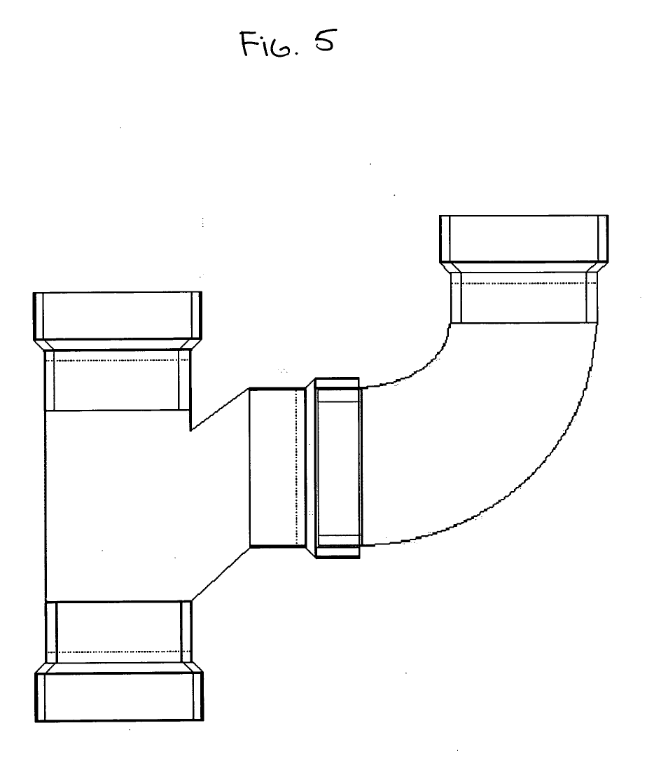

FIG. 5 shows two (2) coupler fittings connected with the preferred embodiments. The 90 degree elbow fitting is inserted in the tee fitting. The female joint is removed from said 90 degree elbow fitting and the male joint it used for connection.

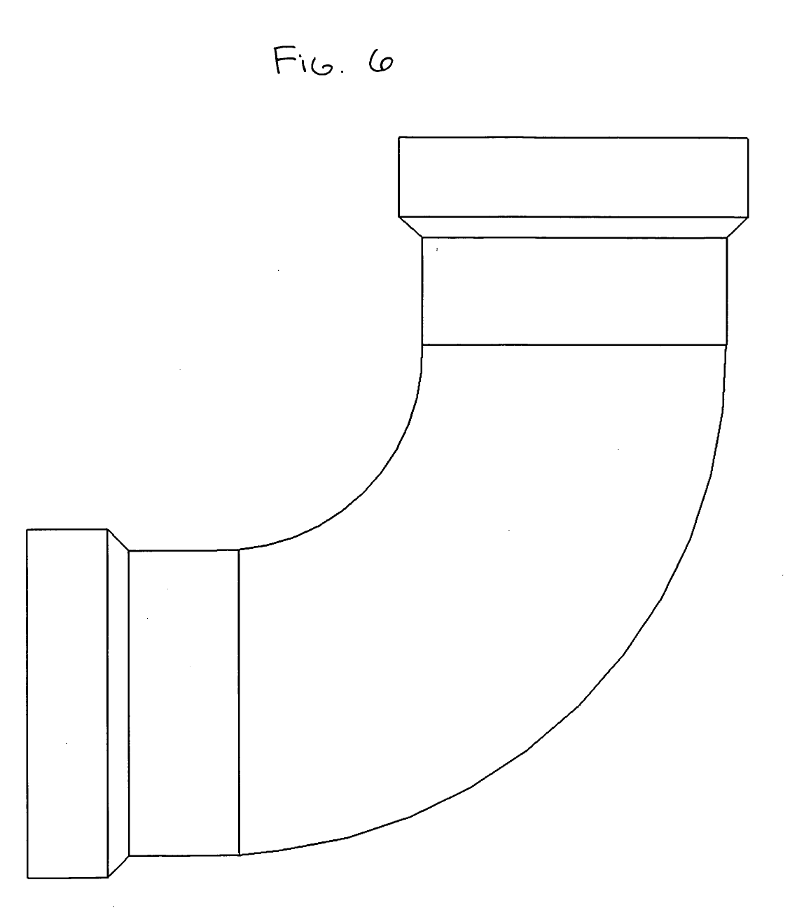

FIG. 6 shows an alternative embodiment with no cut line or etched mark and no instructions to user.

### CONCLUSION, RAMIFICATION, AND SCOPE OF INVENTION

Accordingly the reader will see that the preferred embodiments provide a more economic, universal coupler fitting that will reduce the installation time, supplies, and space. While my above description contains much specificity, this should not limit the scope of the invention, but rather exemplify the preferred embodiments. Many other variations are possible, such as the male and female joints having threads instead of slip joints. Thus, the scope of this invention should not be determined by the embodiments shown, whether preferred or not, but by the appended claims.

I claim:

1. A coupler fitting, comprising:
a) a body and a female joint end or joint ends, with the body immediately behind said female joint end or joint ends, sized inside diameter and outside diameter to the same size as the coupler fitting's corresponding connecting pipe, hose, or tube's inside diameter and outside diameter, and continuing this size throughout a length a minimum of its female joint or joints length, therefore making it male joint size and becoming a male joint once said female joint is removed.
